(19) United States
(12) Patent Application Publication
(10) Pub. No.: US 2020/0112971 A1
(43) Pub. Date: Apr. 9, 2020

(54) CAPC For Uplink Transmissions In New Radio Unlicensed Spectrum

(71) Applicant: MediaTek Singapore Pte. Ltd., Singapore (SG)

(72) Inventors: Mehmet Kunt, Cambridge (GB); Pradeep Jose, Cambridge (GB); Pavan Santhana Krishna Nuggehalli, San Jose, CA (US)

(21) Appl. No.: 16/589,138

(22) Filed: Oct. 1, 2019

Related U.S. Application Data
(60) Provisional application No. 62/740,472, filed on Oct. 3, 2018.

(51) Int. Cl. H04W 72/10; H04W 76/27; H04W 74/08; H04W 16/14; H04W 72/14

(52) U.S. Cl. CPC H04W 72/10; H04W 76/27; H04W 72/14; H04W 16/14; H04W 74/0808

(57) ABSTRACT

Various examples and schemes pertaining to channel access priority class (CAPC) for uplink (UL) transmissions in New Radio (NR) unlicensed spectrum (NR-U) are described. An apparatus implemented in a user equipment (UE) receives, from a network node of a wireless network, a radio resource control (RRC) configuration indicating a first channel access priority class (CAPC) for one or more logical channels. The apparatus determines a second CAPC to be used for a listen-before-talk (LBT) procedure. The apparatus then performs the LBT procedure using the second CAPC to detect whether a channel is clear for transmission.

### CROSS REFERENCE TO RELATED PATENT APPLICATION(S)

The present disclosure is part of a non-provisional application claiming the priority benefit of U.S. Patent Application No. 62/740,472, filed on 3 Oct. 2018, the content of which being incorporated by reference in its entirety.

### TECHNICAL FIELD

The present disclosure is generally related to wireless communications and, more particularly, to techniques pertaining to channel access priority class (CAPC) for uplink (UL) transmissions in New Radio (NR) unlicensed spectrum (NR-U).

### BACKGROUND

Unless otherwise indicated herein, approaches described in this section are not prior art to the claims listed below and are not admitted as prior art by inclusion in this section.

In the 3^{rd} Generation Partnership Project (3GPP) specifications for NR mobile communications, in license assisted access (LAA) and NR-U a transmitter applies listen-before-talk (LBT) before performing a transmission on an unlicensed cell. The transmitter listens to, or senses, a channel to determine whether the channel is free or busy. If the channel is determined to be free, the transmitter can perform the transmission; otherwise, it does not perform the transmission. There are two channel access schemes defined in LAA. In the first scheme, or Type 1, LBT is performed with random backoff and a contention window of a variable size. Additionally, CAPC is used to determine LBT parameters such as sensing interval, contention window size (CW), and maximum channel occupancy time (MOOT). In the second scheme, or Type 2, LBT is performed without random backoff, and sensing interval is fixed. As for determination of the channel access type and CAPC in LAA, it depends on whether it is for dynamic scheduling or for autonomous uplink (AUL).

For dynamic scheduling, a base station (e.g., eNB or gNB) indicates the channel access type (Type 1 or 2) and CAPC in downlink control information (DCI) for UL grant. For Type 1 channel access, a user equipment (UE) uses the CAPC signaled in DCI to determine the LBT parameters (mₚ, cw_{min,p}, cw_{max,p}). CAPC is determined by the base station based on the latest buffer status report (BSR) and received UL traffic from the UE. For Type 2 channel access, CAPC indicates the channel access priority class used to obtain access to the channel, but this does not affect the UE's LBT behavior for sensing the channel (and the sensing interval is fixed).

For AUL, the base station configures CAPC for each logical channel (LCH). The UE uses Type 1 channel access unless ‘COT sharing for AUL’ is indicated in DCI (UL grant). When Type 1 channel access is used, CAPC is determined based on (radio resource control (RRC) configuration) the lowest CAPC of the LCHs with medium access control (MAC) service data unit (SDU) multiplexed in the MAC protocol data unit (PDU). When Type 2 channel access is used, as with dynamic scheduling, CAPC indicates the channel access priority class used to obtain access to the channel, but this does not affect the UE's LBT behavior for sensing the channel (and the sensing interval is fixed).

However, the network may not always have up-to-date visibility of the buffer status in the UE, due to the gap between reporting of the BSR and performing of the UL transmission. Due to logical channel prioritization (LCP), the LCHs multiplexed in MAC PDU may not match the LCHs with data reported in the BSR. Therefore, the network may not be able to accurately predict the actual LCH data transmitted using the UL grant (for dynamic scheduling). As the network indicates the CAPC to the UE in the UL grant, there may be a mismatch between the CAPC used for LBT and the lowest CAPC of the LCHs with SDU multiplexed in the MAC PDU.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to propose concepts, solutions, schemes, techniques, designs, methods and apparatus pertaining to CAPC for UL transmissions in NR-U. Specifically, various schemes proposed herein aim to address aforementioned issues.

In one aspect, a method may involve a processor of an apparatus, implemented in a UE, receiving, from a network node of a wireless network, an RRC configuration indicating a first CAPC for one or more logical channels. The method may also involve the processor determining a second CAPC to be used for an LBT procedure. The method may further involve the processor performing the LBT procedure using the second CAPC to detect whether a channel is clear for transmission.

In one aspect, a method may involve a processor of an apparatus, implemented in a UE, determining a CAPC to be used for an LBT procedure. The method may also involve the processor performing the LBT procedure using the second CAPC to detect whether a channel is clear for transmission. The method may further involve the processor performing an UL transmission to a network node of a wireless network in an NR-U responsive to the LBT procedure indicating the channel being clear for transmission.

In one aspect, an apparatus implementable in a UE may include a transceiver and a processor coupled to the transceiver. The transceiver may be configured to wirelessly communicate with a network node of a wireless network. The processor may be configured to receive, via the transceiver, from a network node of a wireless network an RRC configuration indicating a first CAPC for one or more logical channels. The processor may be also configured to determine a second CAPC to be used for an LBT procedure. The processor may be further configured to perform, via the transceiver, the LBT procedure using the second CAPC to detect whether a channel is clear for transmission.

It is noteworthy that, although description provided herein may be in the context of certain radio access technologies, networks and network topologies such as 5^{th} Generation (5G) and NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, narrowband (NB), narrowband Internet of Things (NB-IoT) and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram depicting an example scenario in accordance with an implementation of the present disclosure.

FIG. 3 is a diagram depicting an example scenario in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CAPC for UL transmissions in NR-U. According to the present disclosure, a number of possible solutions may be implemented separately or jointly. That is, although these possible solutions may be described below separately, two or more of these possible solutions may be implemented in one combination or another.

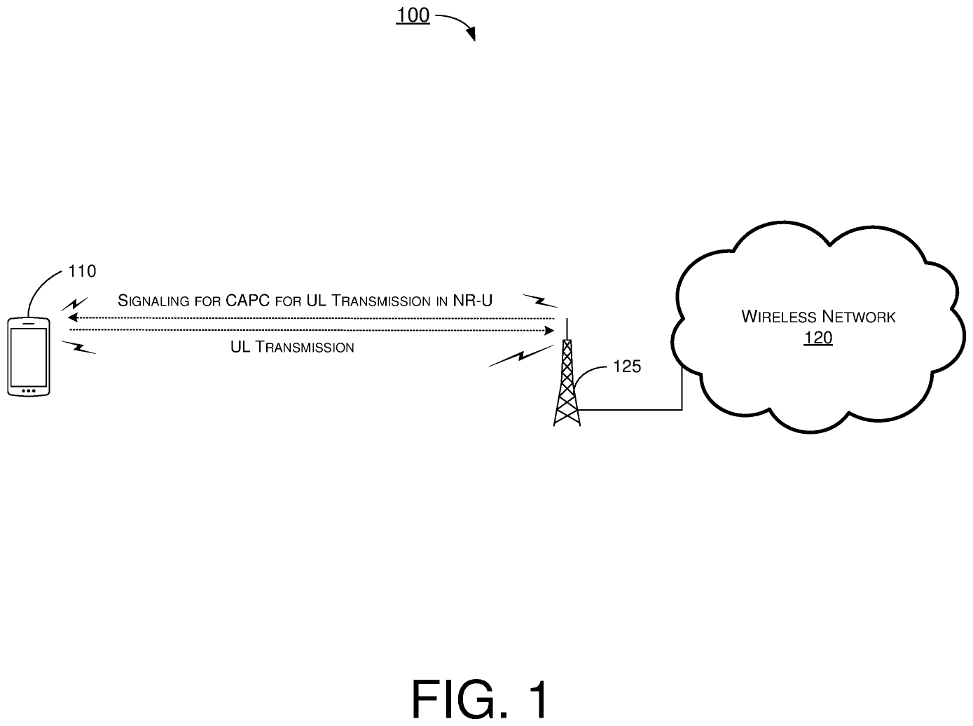

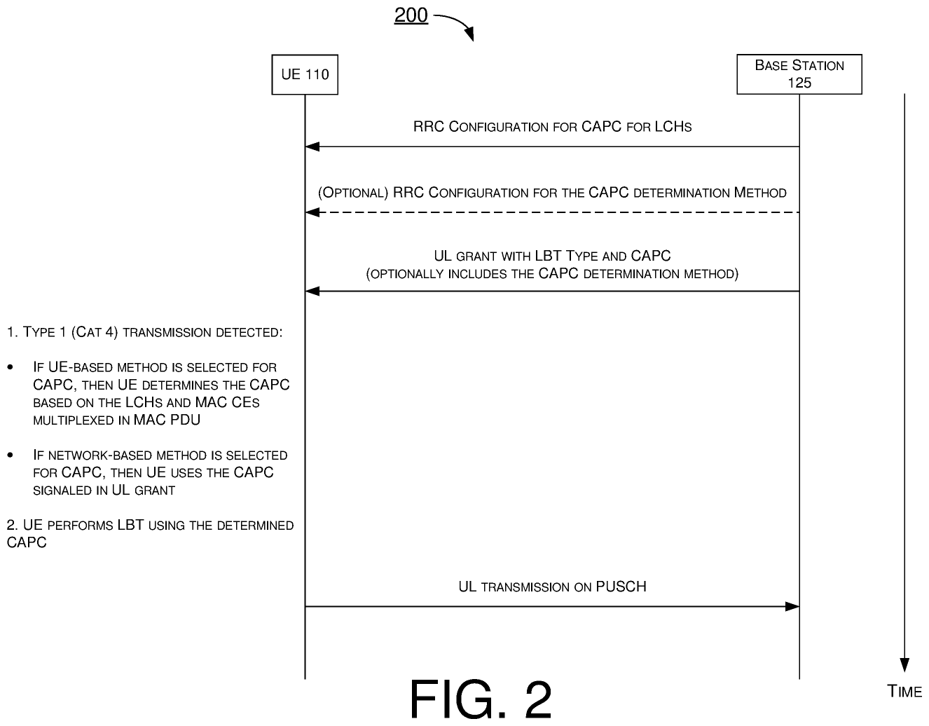

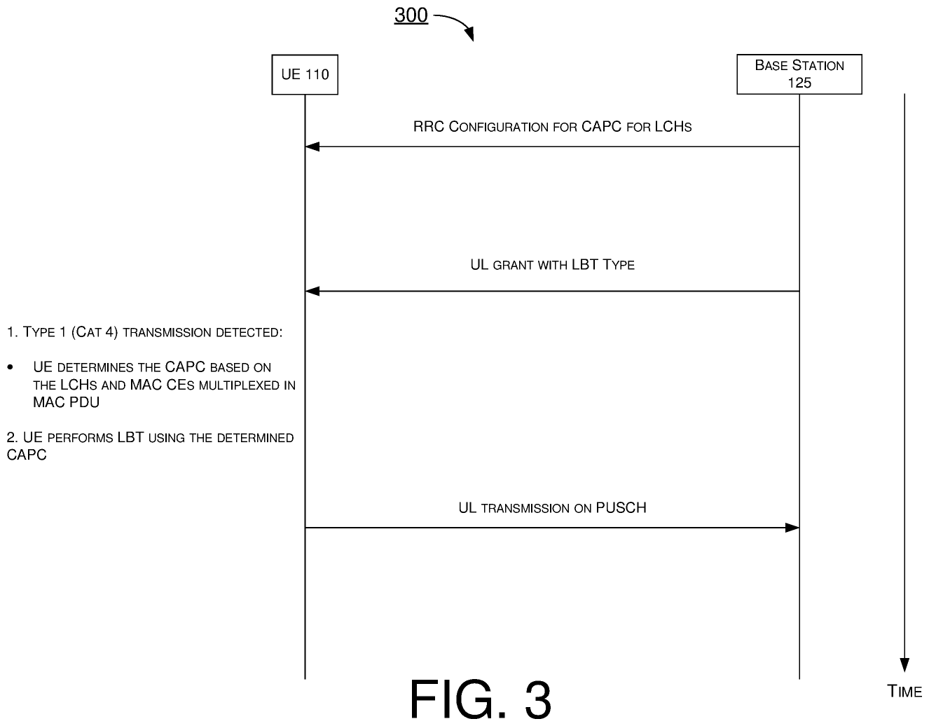

FIG. 1 illustrates an example network environment 100 in which various solutions and schemes in accordance with the present disclosure may be implemented. FIG. 2 and FIG. 3 illustrates example scenarios 200 and 300 in accordance with implementations of the present disclosure. Each of scenarios 200 and 300 may be implemented in network environment 100. The following description of various proposed schemes is provided with reference to FIG. 1˜FIG. 3.

Referring to FIG. 1, network environment 100 may be an NR communication environment involving a UE 110 and a wireless network 120. Wireless network 120 may be in wireless communication with UE 110 via a base station 125 (e.g., an eNB, gNB or transmit/receive point (TRP)). UE 110 may be in or a part of, for example and without limitation, a portable apparatus (e.g., smartphone), a vehicle or a component thereof, a roadside unit (RSU) (e.g., a traffic signal, a street lamp, a roadside sensor or a roadside structure) or an Internet of Thing (loT) device (e.g., a sensor). In network environment 100, UE 110 and wireless network 120 (via base station 125) may implement various schemes pertaining to CAPC for UL transmissions in NR-U in accordance with the present disclosure, as described below.

In NR-U, the CAPC of each logical channel may be determined and signaled to the UE (e.g., UE 110) by the network (e.g., by wireless network 120 via base station 125), regardless of whether configured grants are used or not. Moreover, the LBT type may be signaled in the UL grant for dynamic scheduling, as in LAA. Thus, the present disclosure proposes various concepts, solutions, schemes, techniques, and designs of a hybrid method in which CAPC for an UL transmission may be determined considering either of two approaches, namely: (1) RRC configuration (with CAPC for each logical channel signaled by the network), or (2) CAPC being signaled in the UL grant.

Under a proposed scheme in accordance with the present disclosure, wireless network 120 may signal, via base station 125, the CAPC for each logical channel (e.g., in RRC configuration). Moreover, wireless network 120 may choose to additionally signal the CAPC in the UL grant. Under the proposed scheme, the CAPC to be used for an LBT for an UL transmission may be determined by either of two options. In a first option (Option 1), the CAPC to be used for an LBT for an UL transmission may be the CAPC indicated in the UL grant. In a second option (Option 2), the CAPC to be used for an LBT for an UL transmission may be the CAPC of the logical channels multiplexed in the MAC PDU. As for which of Option 1 and Option 2 to use, the selection may be signaled by wireless network 120 (e.g., in RRC configuration or in a physical downlink control channel (PDCCH)). Alternatively, the CAPC to be used for an LBT for an UL transmission may be defined in a pertinent 3GPP specification such as release 16 (Rel-16) and/or any future release of the 3GPP specification regarding NR mobile communications.

Referring to FIG. 2, scenario 200 is an illustrative example of alternative methods (UE-based and network-based) for CAPC determination. In scenario 200, wireless network 120 may, via base station 125, transmit an RRC configuration signaling for CAPC for one or more logical channels. Optionally, wireless network 120 may, via base station 125, indicate the CAPC determination method in the same or a different transmission of RRC configuration signaling. Additionally, wireless network 120 may, via base station 125, transmit an UL grant with LBT type and CAPC. Optionally, the CAPC determination method may be included in the transmission of UL grant.

Correspondingly, UE 110 may detect signaling from base station 125 indicating Type 1 of LBT to be performed. Based on the signaling received from base station 125, UE 110 may determine the CAPC to be used for an LBT for an UL transmission. In case that UE-based CAPC determination method is selected, UE 110 may determine the CAPC based on the one or more logical channels and one or more MAC control elements (CEs) that are multiplexed in a MAC PDU. In case that network-based CAPC determination method is selected, UE 110 may use the CAPC signaled in the UL grant or the RRC configuration. Subsequently, UE 110 may perform LBT using the determined CAPC and then perform the UL transmission to base station 125 when the channel is clear for transmission.

Referring to FIG. 3, scenario 300 is an illustrative example of UE-based CAPC determination using CAPCs of logical channels with MAC SDU multiplexed in MAC PDU. In scenario 300, wireless network 120 may, via base station 125, transmit an RRC configuration signaling for CAPC for one or more logical channels. Moreover, wireless network 120 may, via base station 125, transmit an UL grant with LBT type.

Correspondingly, UE 110 may detect signaling from base station 125 indicating Type 1 of LBT to be performed. Based on the signaling received from base station 125, UE 110 may determine the CAPC to be used for an LBT for an UL transmission based on the one or more logical channels and one or more MAC CEs that are multiplexed in a MAC PDU. Subsequently, UE 110 may perform LBT using the determined CAPC and then perform the UL transmission to base station 125 when the channel is clear for transmission.

### Illustrative Implementations

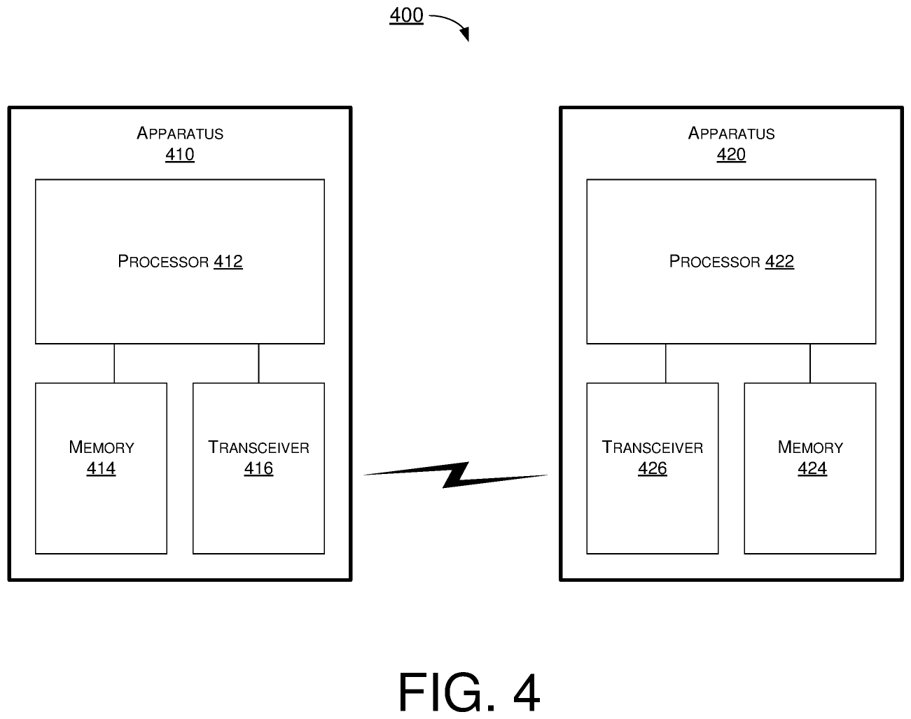

FIG. 4 illustrates an example communication system 400 having an example apparatus 410 and an example apparatus 420 in accordance with an implementation of the present disclosure. Each of apparatus 410 and apparatus 420 may perform various functions to implement schemes, techniques, processes and methods described herein pertaining to CAPC for UL transmissions in NR-U, including various schemes described above as well as processes described below.

Each of apparatus 410 and apparatus 420 may be a part of an electronic apparatus, which may be a UE such as a vehicle, a portable or mobile apparatus, a wearable apparatus, a wireless communication apparatus or a computing apparatus. For instance, each of apparatus 410 and apparatus 420 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 410 and apparatus 420 may also be a part of a machine type apparatus, which may be an IoT or NB-IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. Alternatively, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 410 and apparatus 420 may include at least some of those components shown in FIG. 4 such as a processor 412 and a processor 422, respectively. Each of apparatus 410 and apparatus 420 may further include one or more other components not pertinent to the proposed scheme of the present disclosure (e.g., internal power supply, display device and/or user interface device), and, thus, such component(s) of each of apparatus 410 and apparatus 420 are neither shown in FIG. 4 nor described below in the interest of simplicity and brevity.

In some implementations, at least one of apparatus 410 and apparatus 420 may be a part of an electronic apparatus, which may be a vehicle, a roadside unit (RSU), network node or base station (e.g., eNB, gNB or TRP), a small cell, a router or a gateway. For instance, at least one of apparatus 410 and apparatus 420 may be implemented in a vehicle in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 410 and apparatus 420 may be implemented in the form of one or more IC chips such as, for example and without limitation, one or more single-core processors, one or more multi-core processors, or one or more CISC or RISC processors.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including CAPC for UL transmissions in NR-U in accordance with various implementations of the present disclosure.

In some implementations, apparatus 410 may also include a transceiver 416, as a communication device, coupled to processor 412 and capable of wirelessly transmitting and receiving data. In some implementations, apparatus 410 may further include a memory 414 coupled to processor 412 and capable of being accessed by processor 412 and storing data therein. In some implementations, apparatus 420 may also include a transceiver 426, as a communication device, coupled to processor 422 and capable of wirelessly transmitting and receiving data. In some implementations, apparatus 420 may further include a memory 424 coupled to processor 422 and capable of being accessed by processor 422 and storing data therein. Accordingly, apparatus 410 and apparatus 420 may wirelessly communicate with each other via transceiver 416 and transceiver 426, respectively.

To aid better understanding, the following description of the operations, functionalities and capabilities of each of apparatus 410 and apparatus 420 is provided in the context of an NR communication environment in which apparatus 410 is implemented in or as a wireless communication device, a communication apparatus or a UE (e.g., UE 110) and apparatus 420 is implemented in or as a network node (e.g., base station 125 of wireless network 120).

In one aspect of CAPC for UL transmissions in NR-U in accordance with the present disclosure, processor 412 of apparatus 410, implemented in a UE (e.g., UE 110) may receive, via transceiver 416, from apparatus 420 as a network node (e.g., base station 125) of a wireless network (e.g., wireless network 120) an RRC configuration indicating a first CAPC for one or more logical channels. Additionally, processor 412 may determine a second CAPC to be used for an LBT procedure. Moreover, processor 412 may perform, via transceiver 416, the LBT procedure using the second CAPC to detect whether a channel is clear for transmission.

In some implementations, in determining the second CAPC, processor 412 may determine the first CAPC for the one or more logical channels to be the second CAPC which is used in determining one or more LBT parameters regarding the LBT procedure.

In some implementations, processor 412 may perform additional operations. For instance, processor 412 may receive, via transceiver 416, from apparatus 420 an UL grant. Moreover, processor 412 may perform, via transceiver 416, the UL transmission to apparatus 420 in an NR-U in response to the LBT procedure indicating the channel being clear for transmission. In some implementations, in receiving of the UL grant, processor 412 may receive the UL grant along with a third CAPC. In such cases, in determining the second CAPC, processor 412 may determine the third CAPC received with the UL grant to be the second CAPC which is used in determining one or more LBT parameters regarding the LBT procedure.

In some implementations, processor 412 may perform additional operations. For instance, processor 412 may receive, via transceiver 416, from apparatus 420 an indication of a CAPC determination method. In some implementations, in determining the second CAPC, processor 412 may determine the second CAPC based on the indicated CAPC determination method. In such cases, the indication of the CAPC determination method may be included in the RRC configuration that indicates the first CAPC for the one or more logical channels or in a separate RRC configuration.

In another aspect of CAPC for UL transmissions in NR-U in accordance with the present disclosure, processor 412 of apparatus 410, implemented in a UE (e.g., UE 110) may determine a CAPC to be used for an LBT procedure. Moreover, processor 412 may perform, via transceiver 416, the LBT procedure using the second CAPC to detect whether a channel is clear for transmission. Furthermore, processor 412 may perform, via transceiver 416, an UL transmission to a network node of a wireless network in an NR-U in response to the LBT procedure indicating the channel being clear for transmission.

In some implementations, processor 412 may perform additional operations. For instance, processor 412 may receive, via transceiver 416, from apparatus 420 an indication of a CAPC determination method. In such cases, in determining the CAPC to be used for the LBT procedure, processor 412 may determine the CAPC based on the indicated CAPC determination method.

In some implementations, in receiving the indication of the CAPC determination method, processor 412 may receive an RRC configuration indicating the CAPC determination method.

In some implementations, processor 412 may perform additional operations. For instance, processor 412 may receive, via transceiver 416, from apparatus 420 an RRC configuration indicating a CAPC for one or more logical channels. In some implementations, the indication of the CAPC determination method may indicate a UE-based determination method. In such cases, in determining the CAPC to be used for the LBT procedure, processor 412 may determine the CAPC for the one or more logical channels to be the CAPC to be used for the LBT procedure.

In some implementations, processor 412 may perform additional operations. For instance, processor 412 may receive, via transceiver 416, from apparatus 420 an UL grant for the UL transmission. In some implementations, the indication of the CAPC determination method may indicate a network-based determination method. In such cases, in determining the CAPC to be used for the LBT procedure, processor 412 may determine a CAPC received along with the UL grant to be the CAPC to be used for the LBT procedure.

In some implementations, processor 412 may perform additional operations. For instance, processor 412 may receive, via transceiver 416, from apparatus 420 an RRC configuration indicating a first CAPC for one or more logical channels. Moreover, processor 412 may receive, via transceiver 416, from apparatus 420 an UL grant and a second CAPC. In such cases, in determining the CAPC to be used for the LBT procedure, processor 412 may perform either of the following: (a) determining the first CAPC for the one or more logical channels to be the CAPC to be used for the LBT procedure in response to the indication of the CAPC determination method indicating a UE-based determination method, and (b) determining the second CAPC received along with the UL grant to be the CAPC to be used for the LBT procedure in response to the indication of the CAPC determination method indicating a network-based determination method.

### Illustrative Processes

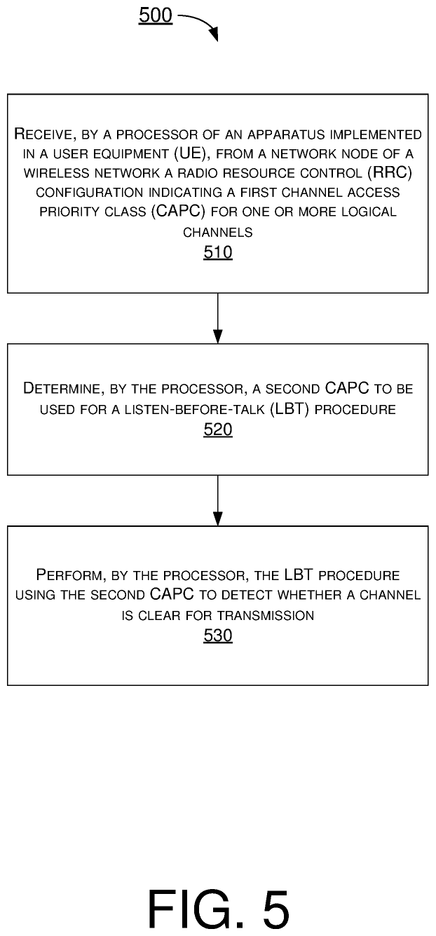

FIG. 5 illustrates an example process 500 in accordance with an implementation of the present disclosure. Process 500 may be an example implementation of the proposed schemes described above with respect to CAPC for UL transmissions in NR-U in accordance with the present disclosure. Process 500 may represent an aspect of implementation of features of apparatus 410 and apparatus 420. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may also be repeated partially or entirely. Process 500 may be implemented by apparatus 410, apparatus 420 and/or any suitable wireless communication device, UE, RSU, base station or machine type devices. Solely for illustrative purposes and without limitation, process 500 is described below in the context of apparatus 410 as a UE (e.g., UE 110) and apparatus 420 as a network node (e.g., base station 125 of wireless network 120). Process 500 may begin at block 510.

At 510, process 500 may involve processor 412 of apparatus 410, implemented in a UE (e.g., UE 110), receiving, via transceiver 416, from apparatus 420 as a network node (e.g., base station 125) of a wireless network (e.g., wireless network 120) an RRC configuration indicating a first CAPC for one or more logical channels. Process 500 may proceed from 510 to 520.

At 520, process 500 may involve processor 412 determining a second CAPC to be used for an LBT procedure. Process 500 may proceed from 520 to 530.

At 530, process 500 may involve processor 412 performing, via transceiver 416, the LBT procedure using the second CAPC to detect whether a channel is clear for transmission.

In some implementations, in determining the second CAPC, process 500 may involve processor 412 determining the first CAPC for the one or more logical channels to be the second CAPC which is used in determining one or more LBT parameters regarding the LBT procedure.

In some implementations, process 500 may involve processor 412 performing additional operations. For instance, process 500 may involve processor 412 receiving, via transceiver 416, from apparatus 420 an UL grant. Moreover, process 500 may involve processor 412 performing, via transceiver 416, the UL transmission to apparatus 420 in an NR-U in response to the LBT procedure indicating the channel being clear for transmission. In some implementations, in receiving of the UL grant, process 500 may involve processor 412 receiving the UL grant along with a third CAPC. In such cases, in determining the second CAPC, process 500 may involve processor 412 determining the third CAPC received with the UL grant to be the second CAPC which is used in determining one or more LBT parameters regarding the LBT procedure.

In some implementations, process 500 may involve processor 412 performing additional operations. For instance, process 500 may involve processor 412 receiving, via transceiver 416, from apparatus 420 an indication of a CAPC determination method. In some implementations, in determining the second CAPC, process 500 may involve processor 412 determining the second CAPC based on the indicated CAPC determination method. In such cases, the indication of the CAPC determination method may be included in the RRC configuration that indicates the first CAPC for the one or more logical channels or in a separate RRC configuration.

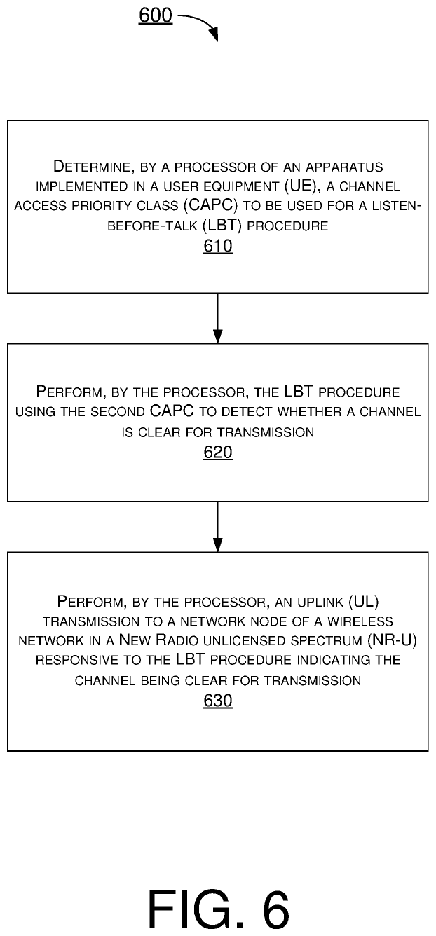

FIG. 6 illustrates an example process 600 in accordance with an implementation of the present disclosure. Process 600 may be an example implementation of the proposed schemes described above with respect to CAPC for UL transmissions in NR-U in accordance with the present disclosure. Process 600 may represent an aspect of implementation of features of apparatus 410 and apparatus 420. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 410, apparatus 420 and/or any suitable wireless communication device, UE, RSU, base station or machine type devices. Solely for illustrative purposes and without limitation, process 600 is described below in the context of apparatus 410 as a UE (e.g., UE 110) and apparatus 420 as a network node (e.g., base station 125 of wireless network 120). Process 600 may begin at block 610.

At 610, process 600 may involve processor 412 of apparatus 410, implemented in a UE (e.g., UE 110), determining a CAPC to be used for an LBT procedure. Process 600 may proceed from 610 to 620.

At 620, process 600 may involve processor 412 performing, via transceiver 416, the LBT procedure using the second CAPC to detect whether a channel is clear for transmission. Process 600 may proceed from 620 to 630.

At 630, process 600 may involve processor 412 performing, via transceiver 416, an UL transmission to a network node of a wireless network in an NR-U in response to the LBT procedure indicating the channel being clear for transmission.

In some implementations, process 600 may involve processor 412 performing additional operations. For instance, process 600 may involve processor 412 receiving, via transceiver 416, from apparatus 420 an indication of a CAPC determination method. In such cases, in determining the CAPC to be used for the LBT procedure, process 600 may involve processor 412 determining the CAPC based on the indicated CAPC determination method.

In some implementations, in receiving the indication of the CAPC determination method, process 600 may involve processor 412 receiving an RRC configuration indicating the CAPC determination method.

In some implementations, process 600 may involve processor 412 performing additional operations. For instance, process 600 may involve processor 412 receiving, via transceiver 416, from apparatus 420 an RRC configuration indicating a CAPC for one or more logical channels. In some implementations, the indication of the CAPC determination method may indicate a UE-based determination method. In such cases, in determining the CAPC to be used for the LBT procedure, process 600 may involve processor 412 determining the CAPC for the one or more logical channels to be the CAPC to be used for the LBT procedure.

In some implementations, process 600 may involve processor 412 performing additional operations. For instance, process 600 may involve processor 412 receiving, via transceiver 416, from apparatus 420 an UL grant for the UL transmission. In some implementations, the indication of the CAPC determination method may indicate a network-based determination method. In such cases, in determining the CAPC to be used for the LBT procedure, process 600 may involve processor 412 determining a CAPC received along with the UL grant to be the CAPC to be used for the LBT procedure.

In some implementations, process 600 may involve processor 412 performing additional operations. For instance, process 600 may involve processor 412 receiving, via transceiver 416, from apparatus 420 an RRC configuration indicating a first CAPC for one or more logical channels. Moreover, process 600 may involve processor 412 receiving, via transceiver 416, from apparatus 420 an UL grant and a second CAPC. In such cases, in determining the CAPC to be used for the LBT procedure, process 600 may involve processor 412 performing either of the following: (a) determining the first CAPC for the one or more logical channels to be the CAPC to be used for the LBT procedure in response to the indication of the CAPC determination method indicating a UE-based determination method, and (b) determining the second CAPC received along with the UL grant to be the CAPC to be used for the LBT procedure in response to the indication of the CAPC determination method indicating a network-based determination method.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus implemented in a user equipment (UE), from a network node of a wireless network a radio resource control (RRC) configuration indicating a first channel access priority class (CAPC) for one or more logical channels;
determining, by the processor, a second CAPC to be used for a listen-before-talk (LBT) procedure; and
performing, by the processor, the LBT procedure using the second CAPC to detect whether a channel is clear for transmission.

2. The method of claim 1, wherein the determining of the second CAPC comprises determining the first CAPC for the one or more logical channels to be the second CAPC which is used in determining one or more LBT parameters regarding the LBT procedure.

3. The method of claim 1, further comprising:
receiving, by the processor, from the network node an UL grant; and
performing, by the processor, the UL transmission to the network node in a New Radio unlicensed spectrum (NR-U) responsive to the LBT procedure indicating the channel being clear for transmission.

4. The method of claim 3, wherein the receiving of the UL grant comprises receiving the UL grant along with a third CAPC.

5. The method of claim 4, wherein the determining of the second CAPC comprises determining the third CAPC received with the UL grant to be the second CAPC which is used in determining one or more LBT parameters regarding the LBT procedure.

6. The method of claim 1, further comprising:
receiving, by the processor, from the network node an indication of a CAPC determination method,
wherein the determining of the second CAPC comprises determining the second CAPC based on the indicated CAPC determination method.

7. The method of claim 6, wherein the indication of the CAPC determination method is included in the RRC configuration that indicates the first CAPC for the one or more logical channels or in a separate RRC configuration.

8. A method, comprising:
determining, by a processor of an apparatus implemented in a user equipment (UE), a channel access priority class (CAPC) to be used for a listen-before-talk (LBT) procedure;
performing, by the processor, the LBT procedure using the second CAPC to detect whether a channel is clear for transmission; and
performing, by the processor, an uplink (UL) transmission to a network node of a wireless network in a New Radio unlicensed spectrum (NR-U) responsive to the LBT procedure indicating the channel being clear for transmission.

9. The method of claim 8, further comprising:
receiving, by the processor, from the network node an indication of a CAPC determination method,
wherein the determining of the CAPC to be used for the LBT procedure comprises determining the CAPC based on the indicated CAPC determination method.

10. The method of claim 9, wherein the receiving of the indication of the CAPC determination method comprises receiving a radio resource control (RRC) configuration indicating the CAPC determination method.

11. The method of claim 9, further comprising:
receiving, by the processor, from the network node a radio resource control (RRC) configuration indicating a CAPC for one or more logical channels,
wherein the indication of the CAPC determination method indicates a UE-based determination method, and
wherein the determining of the CAPC to be used for the LBT procedure comprises determining the CAPC for the one or more logical channels to be the CAPC to be used for the LBT procedure.

12. The method of claim 9, further comprising:
receiving, by the processor, from the network node an UL grant for the UL transmission,
wherein the indication of the CAPC determination method indicates a network-based determination method, and
wherein the determining of the CAPC to be used for the LBT procedure comprises determining a CAPC received along with the UL grant to be the CAPC to be used for the LBT procedure.

13. The method of claim 9, further comprising:
receiving, by the processor, from the network node a radio resource control (RRC) configuration indicating a first CAPC for one or more logical channels; and
receiving, by the processor, from the network node an UL grant and a second CAPC,
wherein the determining of the CAPC to be used for the LBT procedure comprises:
determining the first CAPC for the one or more logical channels to be the CAPC to be used for the LBT procedure responsive to the indication of the CAPC determination method indicating a UE-based determination method, and
determining the second CAPC received along with the UL grant to be the CAPC to be used for the LBT procedure responsive to the indication of the CAPC determination method indicating a network-based determination method.

14. An apparatus implementable in a user equipment (UE), comprising:
a transceiver configured to wirelessly communicate with a network node of a wireless network; and
a processor coupled to the transceiver and configured to perform operations comprising:
receiving, via the transceiver, from a network node of a wireless network a radio resource control (RRC) configuration indicating a first channel access priority class (CAPC) for one or more logical channels;
determining a second CAPC to be used for a listen-before-talk (LBT) procedure; and
performing, via the transceiver, the LBT procedure using the second CAPC to detect whether a channel is clear for transmission.

15. The apparatus of claim 14, wherein, in determining the second CAPC, the processor is configured to determine the first CAPC for the one or more logical channels to be the second CAPC which is used in determining one or more LBT parameters regarding the LBT procedure.

16. The apparatus of claim 14, wherein the processor is further configured to perform operations comprising:
receiving, via the transceiver, from the network node an UL grant; and
performing, via the transceiver, the UL transmission to the network node in a New Radio unlicensed spectrum (NR-U) responsive to the LBT procedure indicating the channel being clear for transmission.

17. The apparatus of claim 16, wherein, in receiving the UL grant, the processor is configured to receive the UL grant along with a third CAPC.

18. The apparatus of claim 17, wherein, in determining the second CAPC, the processor is configured to determine the third CAPC received with the UL grant to be the second CAPC which is used in determining one or more LBT parameters regarding the LBT procedure.

19. The apparatus of claim 14, wherein the processor is further configured to perform operations comprising:
receiving, via the transceiver, from the network node an indication of a CAPC determination method,
wherein the determining of the second CAPC comprises determining the second CAPC based on the indicated CAPC determination method.

20. The method of claim 19, wherein the indication of the CAPC determination method is included in the RRC configuration that indicates the first CAPC for the one or more logical channels or in a separate RRC configuration.
